(19) United States
(12) Patent Application Publication
(10) Pub. No.: US 2003/0041036 A1
(43) Pub. Date: Feb. 27, 2003

(54) Method and system for providing financial information

(76) Inventors: Gioel Molinari, Fort Lauderdale, FL (US); Jonathan Rothberg, Guilford, CT (US); Anthony Glaviano, Boca Raton, FL (US); Mathew Morton, Boca Raton, FL (US); Sergio Mendez, Boca Raton, FL (US); Diego Baron, Miami, FL (US); David S. McFarland, Marietta, GA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 09/929,377

(22) Filed: Aug. 13, 2001

(51) Int. Cl. G06F 17/60

(52) U.S. Cl. 705/77

(57) ABSTRACT

A method and system is disclosed for providing to a plurality of users information obtained over a computer network, wherein each of the plurality of users each use a remote computer. The method includes allowing a plurality of users each to specify one or more investment preferences such that an investor profile can be created. A server creates a plurality of tasks from the plurality of investment preferences and uses these tasks to monitoring information about financial instruments, such as equities, by executing at least some of the plurality of tasks on user computers. The tasks send to the server information about the one or more financial instruments using task report messages. The server then takes the information and filters it and distributes the information about the financial instruments to the interested users based upon their respective investment preferences. Using methods disclosed herein, a plurality of users can specify a narrow or broad investment strategy and be efficiently provided with investment information of interest to them.

### FIELD OF THE INVENTION

The present application relates generally to a method and system for providing investment information to a plurality of users. More specifically, it relates to the use of distributed computing to provide investment information to a plurality of users.

### BACKGROUND OF THE INVENTION

Many investment strategies are based on models that utilize readily available securities performance information. One such model is a 5-Day Breakout Model that relies on a momentum trading strategy. An assumption of this strategy is that an equity which moves above its 5-day high will continue to rise and the model should go long; conversely, an equity that drops below its 5-day low will continue to drop and the model should go short. Trading systems that utilize these models can be difficult to implement on a system that supports a plurality of users who obtain investment information from diverse and distributed sources.

### SUMMARY OF THE INVENTION

In one embodiment, the invention is a method of providing information obtained over a computer network to a plurality of users each using a remote computer. The method includes obtaining a plurality of investor profiles each specifying a user's investment preferences; defining at least one task as a function of the investment preferences; monitoring information about one or more financial instruments by at least one of the plurality of tasks being executed on a client computer; receiving from the tasks information about the one or more financial instruments; and distributing the information about the one or more financial instruments to at least one of the plurality of users as a function of said user's investment preferences.

In another embodiment of the invention, the invention includes an apparatus for providing information obtained over a computer network to a plurality of users each using a remote computer. The apparatus comprises a server coupled to the computer network, wherein the server is programmed to: obtain a plurality of investor profiles each specifying a user's investment preferences; define at least one task as a function of the investment preferences; monitor information about one or more financial instruments by at least one of the plurality of tasks being executed on a client computer; receive from the tasks information about the one or more financial instruments; and distribute the information about the one or more financial instruments to at least one of the plurality of users as a function of said user's investment preferences.

### BRIEF DESCRIPTION OF THE DRAWINGS

For a better understanding of the present invention, reference is made to the drawings which are incorporated herein by reference and in which:

FIG. 1 is a block diagram of the system for providing information about financial instruments.

FIG. 2 is a block diagram of a system in accordance with the invention.

FIG. 3 is a block diagram illustrating the creation of a task, an assignment and an agent used with the system of FIG. 1.

FIG. 4 is a block diagram illustrating assignment priority for the system of FIG. 1.

FIG. 5 is a block diagram illustrating the task manager the system of FIG. 1 interacting with an information feed.

FIG. 6 is a flowchart illustrating the lifecycle of a task used with the system of FIG. 1.

FIG. 7 is a block diagram of the task report receiver of the system of FIG. 1.

FIG. 8 is a flowchart illustrating the operation of the profile miner used with the system of FIG. 1.

FIG. 9 is a flowchart illustrating the operation of the trading module used with the system of FIG. 1.

FIG. 10 is a block diagram of a trade message used with the system of FIG. 1.

FIG. 11 is an illustration of an exemplary web page to accept information about a user's investment strategy stored on the system of FIG. 1.

FIGS. 12A-C are sample Java task programs usable by the tasks used with the system of FIG. 1

### DETAILED DESCRIPTION OF THE INVENTION

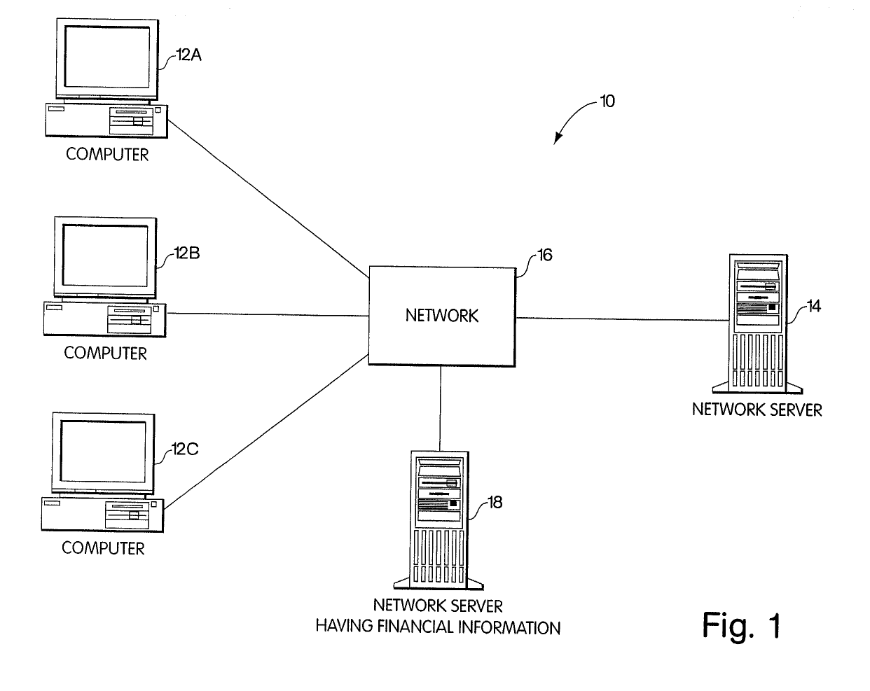

FIG. 1 shows a system 10 in accordance with the present invention. The system 10 allows a plurality of users at remotely located computers 12a-12c to obtain information from and send confirmation to the server 14 through network 16. The information can include information about financial instruments such as, but not limited to, equities, futures, options, commodities or currency. The server 14 can collect information about investor profiles that each specify one or more preferences of one of the plurality of users at remotely located computers 12a-12c and can also collect financial information from one or more information servers such as financial information server 18. From the investor profile information, the server creates and assigns one or more tasks to obtain relevant financial information about the financial instruments that fall with the plurality of investment strategies. Once the server 14 has the financial information about a relevant financial instrument, the server determines which users have an interest about the financial instrument based upon their investor profile and provides a notification to each interested user about the activity of the financial instrument.

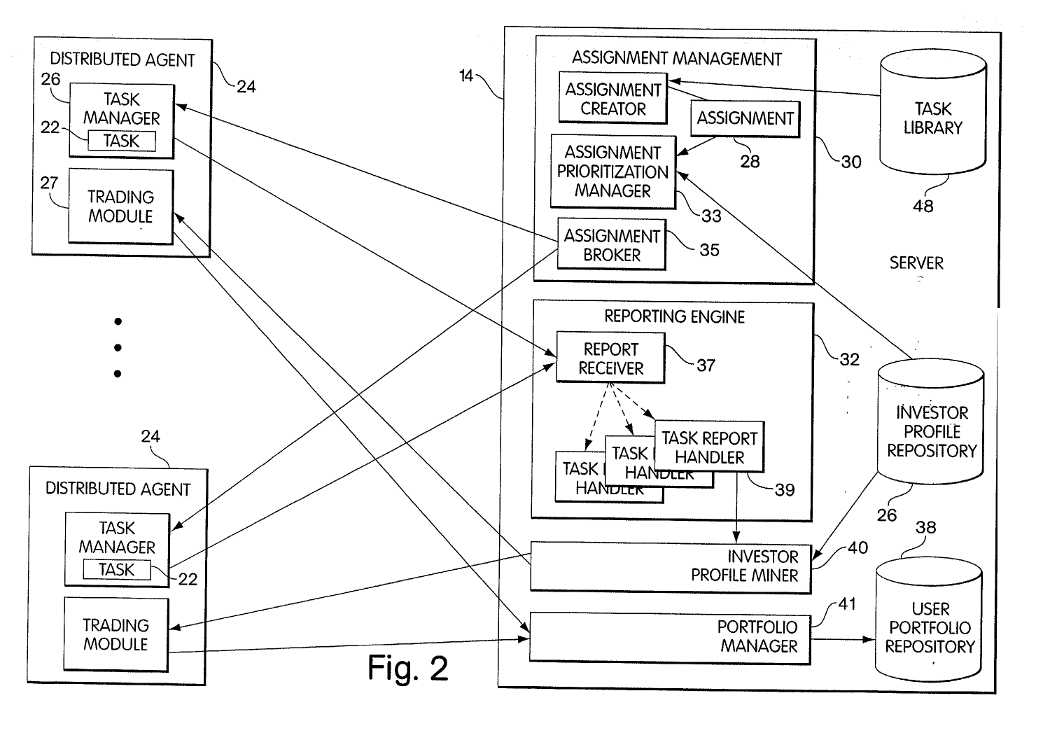

A system having a server 14 and one or more agents 24 in accordance with the invention is shown shown in more detail in FIG. 2. The server 14 includes an assignment management module 30, a reporting module 32, a task library database 48, an investor profile database 36, a user profile database 38, an investor profile miner 40, and a portfolio manager 41.

The assignment management module 30 includes an assignment creator 31, a reporting engine module 32, an assignment prioritization engine 33 and an assignment broker 35. The reporting engine module 32 includes a report receiver 37, and one or more task report handlers 39. The assignment creator 31 creates for each task 22 an assignment 28 that contains information about the task which allows the server 14 to track and manage the task.

To obtain financial information for the server 14, the system 10 uses a task 22, which is managed by task manager 26. A task 22 is a self-contained executable object that is executed on a distributed agent 24 to perform an operation for the server 14. The distributed agent can also include a trading module 26 to conduct security trades and report them to server 14.

The distributed tasks 22 are expected to do most of the computations, reporting back to the server through task report handlers 92 only when relevant financial information is uncovered. When a task 22 finds relevant information, the distributed agent sends a task report message to the server for processing. If the task report handler 39 identifies the report as containing useful information, it will create an opportunity signal that recommends a buy or sell of the security.

Once the server 14 receives one or more opportunity signals about one or more financial instruments, the server passes the opportunity signal to the profile miner 40 to filter the opportunity signals and generate personal trade messages to appropriate users. The profile miner 40 will use the investor profile information of each user to determine which user will be interested in which opportunity. The system will then transmit a notification to the computers of appropriate users to notify them of the information about the one or more financial instruments.

In one aspect of an embodiment of the invention, the system can perform one or more trades personalized for each user. After identifying a trading opportunity, the system determines if the opportunity is applicable to each user. A trading opportunity is valid for a user if it matches their investor profile.

The investor profile for a user can be updated via a website and contains the criteria that the server uses to evaluate trading opportunities. FIG. 11 shows an exemplary web page that allows a user to indicate his investor profile information to the system. This web page is dynamically generated and updated at the user's request. On this web site, a user can provide data to specify the size of a desired security trade and the type of security to be traded. A user may specify a range of share amounts, total value of trade, and price per share. The user also specifies what kinds of securities are of interest based on the securities' volatility, market capitalization, trading volume, and index membership (i.e. Dow Jones industrial average, Standard & Poor's 500, etc.).

Tasks and Assignments

A task 22 is a self-contained executable object that is executed by a distributed agent to perform an operation for the server on a client computer. A task 22 can have a simple logical function such as collecting information about or watching for activity regarding an equity. A more complex function of a task could the collection of news from a variety of Internet sources or the optimization of an analysis model that relates to a particular security. For example, a task could perform an optimization analysis on the most profitable parameters used in another task, such as the 5-day breakout task, which is described below. Each task 22 has it's parameters collected and distributed to one or more distributed agents that undertake the task. The agent and associated task is run on a client computer. Each agent can be installed on a client computer by downloading the agent from a network such as an internet website or by copying the agent from a floppy disk, CD-Rom or other computer readable medium.

The server 14 creates an assignment that contains information about a task 22, such as, but not limited to, the type of task 22, a list of parameters necessary to construct the task 22, the current state of the assignment (running, completed, or unassigned), and the identifier of the node currently executing the task 22, if applicable. Since a task 22 might be assigned to several different distributed agents over the course of its lifespan, the assignment describing the task 22 is maintained in a task library database coupled to the server to maintain information about its status. Each distributed agent can update the status of the tasks which are assigned to it by updating the assignment in a prioritized assignment list, which can be stored on an assignment list database (not shown).

Assignment Creation

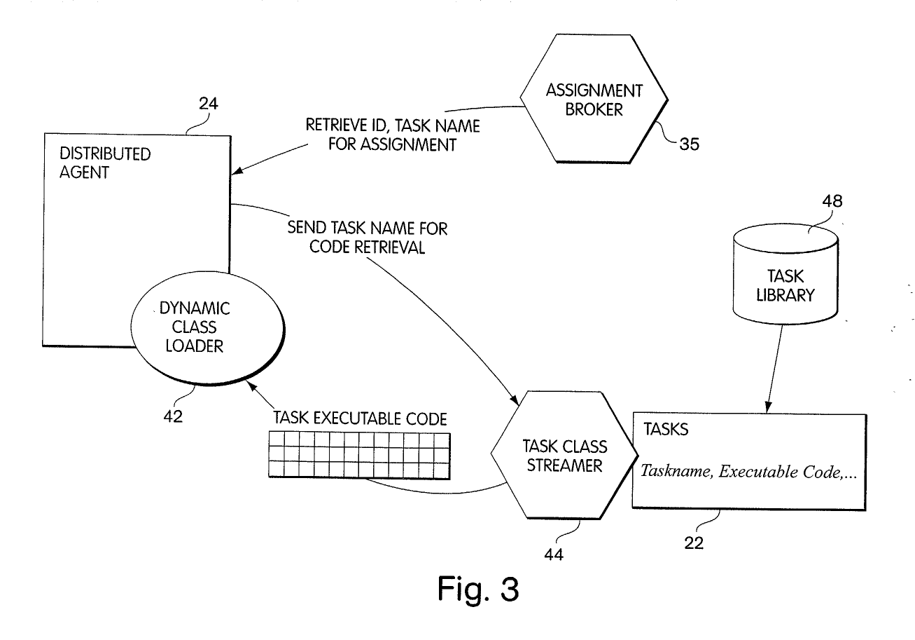

Before an instance of a task 22 can be initialized and executed, it must be defined on the server 14 and assigned to a distributed agent 24. Referring to FIG. 3, a task library database 48 contains task definitions that include the executable code which can be remotely loaded and executed by the distributed agents. These task 22 definitions are maintained in the task library database 48 for the purposes of tracking and maintenance. When requested the task definition is sent or streamed to the distributed agent 24 by the task class streamer 44 and loaded by the dynamic task loader 42. Having the task definitions stored in a task library 48 and loadable by the dynamic task loader 42 provides a flexible architecture upon which new task definitions can be introduced and existing task definitions can be revised, without requiring changes in the executable code of the distributed agent 24. Numerous types of task definitions are contained in the task library 48. For example, a distinction is necessary for tasks 22 that need to execute during market hours versus tasks that can execute at any time. As each assignment 28 is created it is given the name of the task type that should be executed by the distributed agent 24 as an attribute. The dynamic task loader 42 of the distributed agent 24 then loads the task definition. In addition, each assignment 28 has an attribute representing the initialization parameters, such as parameters for the securities buy and sell process, data set references if the task is analyzing a data set, or parameters regarding the location of data sources that the task requires. The distributed agent 24 passes these parameters to the task during instantiation. This attribute could, for example, take the form of a java serialized hashtable object. The assignment list database also keeps track of the date and time the assignment 28 was created, assigned, and completed and the current status of the assignment: assigned, unassigned or running.

The assignment 28 creation process can be run periodically or on an as needed basis. Reasons for running the assignment creation process include: the introduction of new tasks into the database, the modification of the parameters passed in to any task, or the addition or subtraction of watchable ticker symbols.

In addition to the assignment metadata, such as the assignment creation datestamp, the order of assignment priority and the assignment current status, the assignment list database keeps a mapping from assignments to trading symbols being monitored. The assignment 28 creation process is responsible for maintaining this mapping for each of the available assignments in the database.

The assignment 28 creation process requires two steps. First, the assignment metadata is generated and stored. This includes the task name, the parameter object to pass to the task, the creation date and a unique assignment identifier. Once the metadata is stored on the assignment list database, the corresponding mapping from the assignment to ticker symbols being monitored is also stored on the assignment list database. For example assignment X is created to watch CSCO, MSFT, and HWP. The metadata for assignment X is generated and storedon the assignment list database followed by the mapping information for each of the three symbols.

Since the task database could have multiple executable tasks, the assignment creation process will iterate through this list of executable tasks and ensure that there is an assignment in the database for each task and for each symbol for which information is desired.

The Assignment Broker

The assignment broker 35 is responsible for distributing tasks 22 to distributed agents. Distributed agents are represented on the server by entities known as nodes. A node's identification include, but are not limited to, a unique id, a current status (logged on or logged off), and the number of tasks 22 currently executing. When a user logs on to the server via the distributed agent, the assignment broker 35 first determines how many tasks 22 the particular distributed agent can run simultaneously by looking up the tasks executing attribute of the node and subtracting it from the maximum number of tasks 22 a node is allowed to execute. Next, the assignment broker 35 requests from the assignment manager the unique identifiers of the assignments with the highest priority. The assignment broker 35 loops through the list of assignments 28 and modifies two attributes of the assignment: the state of the assignment is set to running and the node id is set to that of the node representing the distributed agent. The assignment broker 35 sends the distributed agent a get task message, via a messaging service, which consists of the assignment id representing the task. When the distributed agent receives the get task 22 message, it requests from the assignment broker 35 the assignment's information that it needs to construct and execute the task 22.

Managing Assignment Priorities

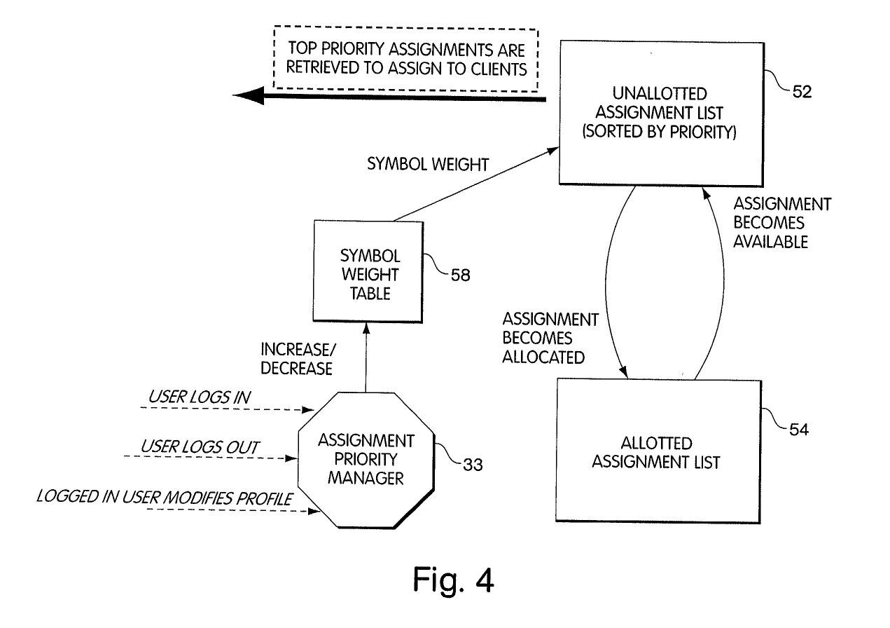

The system maintains priorities for every assignment 28 in the database. These priorities are used to determine the order in which assignments and its associated task are distributed to distributed agents. Higher priority assignments 28 will be allotted before lower priority assignments. Referring to FIG. 4, when the assignment priority manager 33 is initialized, it creates a list of all known trading symbols. For each of these symbols, the assignment priority manager 33 assigns an initial weight of 0. The weight value indicates the number of currently logged in distributed agents 24 that would be interested in receiving a trade signal for that particular symbol. Each assignment 28 in the database is mapped to 1 or more symbols. These are the symbols that each assignment monitors. Each assignment's priority is determined by the sum of all the weights of the symbols which it monitors. For example, if one assignment monitored CSCO (3 logged in distributed agents interested) and MSFT (4 logged in distributed agents interested) its priority would be 7. This assignment would be distributed before an assignment with a lower priority of 4.

A list of the currently unallocated assignments 28 is kept in the unallotted assignment list 56. This list is maintained in sorted order by assignment priority since it is used by the assignment broker 35 to allot assignments to distributed agents as they connect to the system. In addition, a list of allocated and running assignments is kept in the allotted assignment list 54 to prevent an assignment and its associated task from being distributed to the same distributed agent multiple times or to different distributed agents simultaneously. When an assignment is ready for distribution, it is put back on the unallotted assignment list 56.

It is the responsibility of the assignment priority manager 33 to manage the symbol weights. The assignment priority manager 33 updates the value of these symbol weights in the symbol weight table 58 based on events such as: distributed agent 24 logs in, distributed agent logs out, logged in user changes their investor profile. A distributed agent 24 logging in would trigger an increase in weights of all the symbols for which the user of that distributed agent has shown an interest either directly or indirectly via their investor profile. When that same distributed agent logs out the event would trigger a decrease in the weights of these same symbols. A user modifying their investor profile causes a change in the weights of the affected symbols. This feedback mechanism allows the system as a whole to react in near real-time to shifts in investor preferences by ensuring that the next allocated assignment monitors the most relevant symbols for the user base.

Even if a user should shut down his computer or log of the network 16, the network server 14 could still send a notification to a user through, for example, a pager, a standard or mobile telephone, or a wireless e-mail device such as a Blackberry device.

Symbol weights are tier based. For example, a symbol is more valuable if users have an open position for that given symbol than if they just have expressed interest via the investor profile. If 5 users were to have an open position on symbol a and no users were interested in it, it would have a higher worth than a symbol for which no users had an open position but 500 users were interested. In this case the tier of having an open position carries more weight than the tier simply denoting interest in the symbol.

Task Lifecycle

Central to the operation of the invention is the ability to distribute and execute tasks 22 on each distributed agent 24 dynamically. For this reason the distributed agent 24 is designed to asynchronously respond to a server 14 command to retrieve and run a task 22. The distributed agent 24 accepts and then acts as the host for all assigned tasks. A distributed agent 24 may have zero or more tasks in its execution environment at any given time. Each task 22 executes until it completes nominally, is cancelled, or aborts due to an exception. Each task 22, using services made available through the distributed agent, is provided with a portion of the host computer's processing power and network bandwidth as well as access to its information feeds. To maximize flexibility and efficiency tasks 22 are designed to run without intervention.

Command Receiver

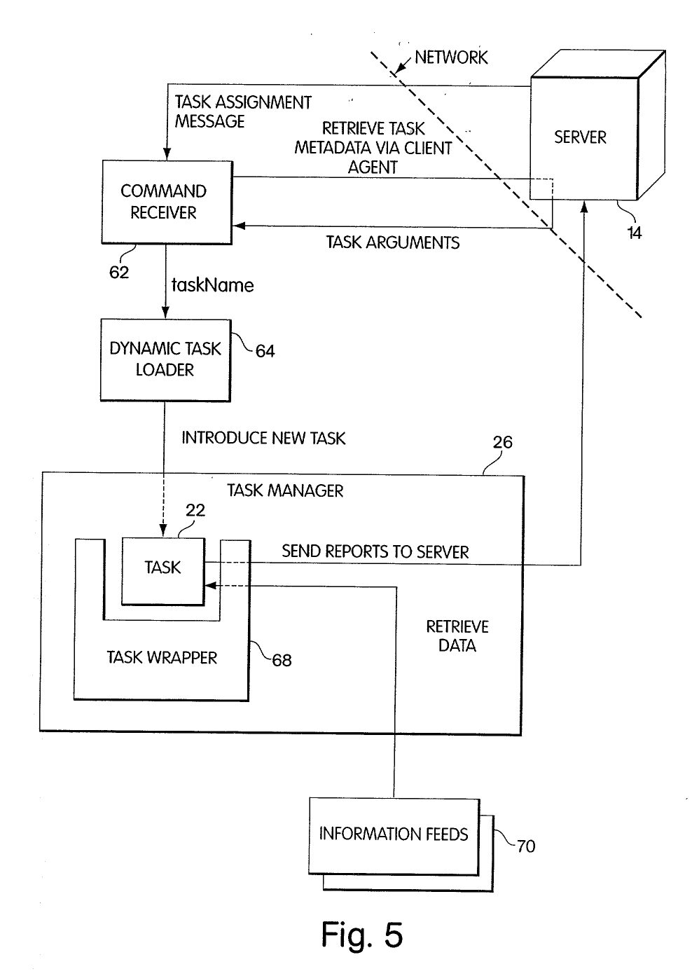

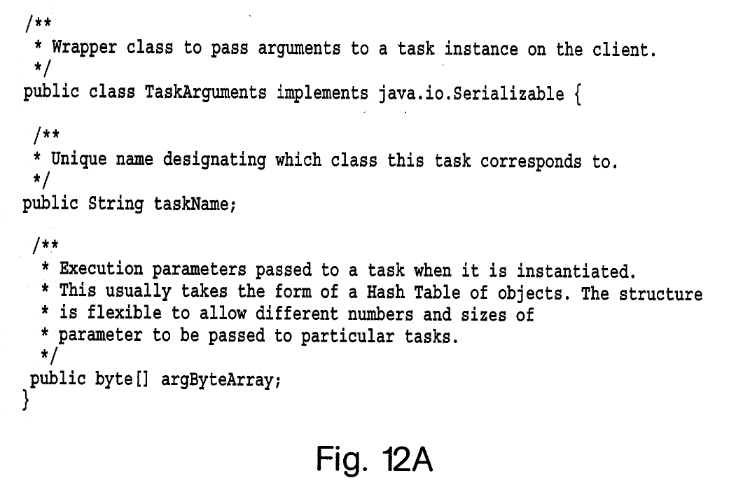

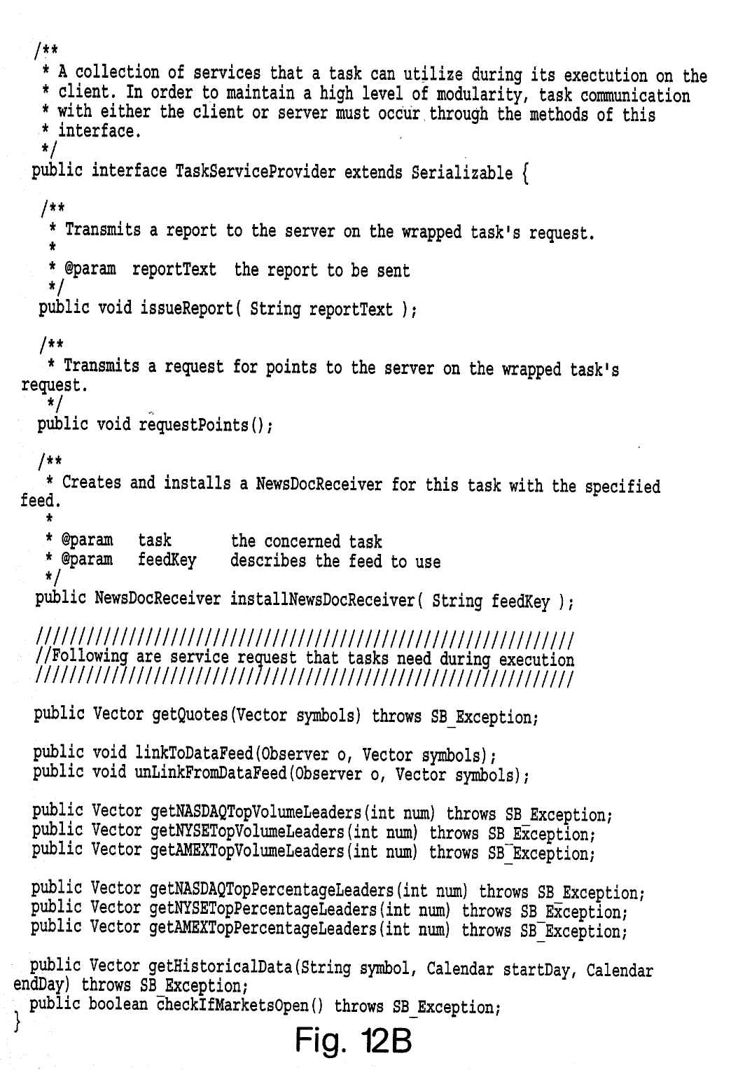

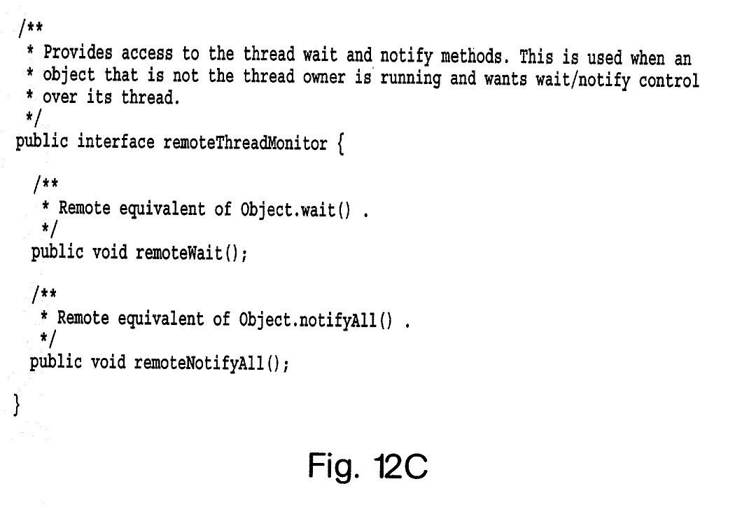

Referring to FIG. 5, the command receiver 62 is a component of the distributed agent that provides the gateway by which the server 14 assigns a task 22 to the distributed agent. Once a task 22 is obtained from the server 14, the distributed agent is wholly responsible for managing the task 22. When the distributed agent comes online, the server 14 assigns it tasks 52. The distributed agent must first come online to receive and execute tasks. The server 14 sends a gettaskmessage to the distributed agent, instructing it to send a query back to the server 14 for a new task 22. The first step of a task's lifecycle, on the distributed agent 24 is the installation phase (phase 1). Phase 1 begins when the command receiver 62 receives a task arguments message from the server 14. Next the command receiver 62 uses the client agent to retrieve a task arguments object from the server. For an implementation example of task arguments see FIG. 12A. Task arguments contains the parameters necessary for an instance of the task 22 to be identified and configured. The command receiver 62 interprets the task arguments and passes instructions to the dynamic task loader 64 for further action 56.

Dynamic Task Loader

Each task 22 has a unique name, called its taskname, which distinguishes it from other tasks. The incoming task arguments contains the appropriate taskname for the new task 22 to be constructed. Using the taskname provided, the dynamic task loader 64 attempts to create a new instance of the task 22 object. The dynamic task loader 64 will first look in memory to see if the task's definition has already been loaded. If it has already been loaded then the class is retrieved from memory, otherwise the dynamic task loader 64 will communicate with the server 14 to have the task 22 definition streamed across the network and loaded locally. The task 22 is then configured according to the parameters declared in the task arguments. Phase 1 is now complete and the new task 22 is ready to execute. Flow control passes back to the command receiver 62. The next step in a task's lifecycle, the operations phase (phase 2), begins when the command receiver 62 orders the task manager 26 to process the task 22.

Task Manager

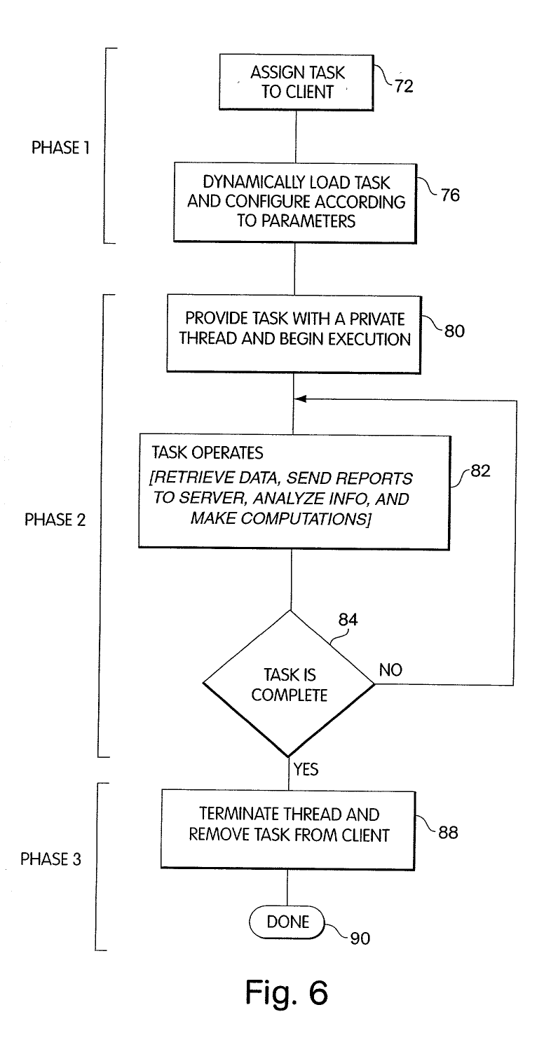

Referring to FIG. 6, the task manager 26 can be part of the distributed agent 24 that provides an execution environment at step 80 for the task 22 for the rest of its lifecycle. Each task 22 is immediately assigned a task wrapper 68 and all of the responsibility for the task's activity is delegated to its task wrapper 68. A new task wrapper 68 is created specifically for an incoming task 22 and these two entities maintain a one-to-one relationship. The task manager 26 maintains a community of task wrapper 68 entities. Each task's task wrapper 68 provides services to the task 22 as mentioned below. The function of the task manager 26 is to provide a gateway to add new tasks and also to provide public access to the tasks. All the tasks and their task wrappers 68 are encapsulated within the task manager 26.

Task Wrapper

The task wrapper 68 provides its associated task 22 with a thread to run in step 80. In addition, the task wrapper 68 makes distributed agent side services available which are described in two interfaces: task service provider and remote thread monitor. For implementation examples of these interfaces see FIGS. 12B and 12C respectively. From this point on the task 22 runs independently at step 82 and may make computations and network accesses as it sees fit by using any of the services provided by its task wrapper 68. A task wrapper 68 an also include information that will provide the task with notification functionalities or data feed interface information.

Once a task 22 has completed its functionality it signals completion, indicating the end of phase 2. Task wrapper 68 periodically checks for this signal at step 84 and once the signal is recognized the final step, the finalization phase (phase 3), begins. The task wrapper 68 removes its task 22 and terminates its thread at step 88. The duty of the task wrapper 68 is complete at step 90 and it removes itself from the task manager 26.

Task Reports

During its normal execution, a task 22 may wish to communicate reports back to the server. The format of these reports is task dependant, but the task manager 26 provides a standard mechanism for tasks to issue their reports. The task service provider transmits these reports to the server as a task report message, which can contain the node ID of the distributed agent, the assignment ID of the task issuing the report, a flag indicating whether or not the task is complete, and the actual report, usually in XML format. When the server 14 receives a report, it insures that the report is from a valid distributed agent 24 and assignment 28. The following is an exemplary task report message.

public class TaskReportMessage {

public int AssignmentID;

public int nodeID;

public String reportText;

public 52lean isTaskcomplete;}

Task Report Handler

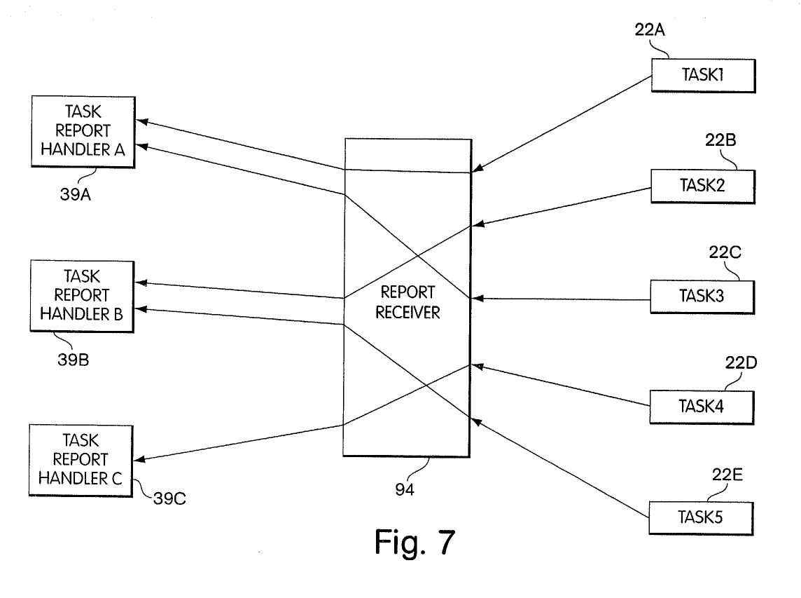

Referring to FIG. 7, each task 22a-e typically has at least one task report handler 39a-c. In their most basic configuration, many tasks 22 have a relationship to one task report handler 39; however, one could write the models to allow the many tasks 22 to have relationships to many task report handlers 39. The relationship between task 22 and task report handler 39 can be stored in the task database 48. A report receiver at step 94 queries this database to determine which task report handler 39 should receive the task report and passes the task report on to the appropriate task report handler or handlers 39. The task report handlers 39 are expected to filter the task reports for possible trading opportunities and to maintain a global model state. This state can be model dependant and can be stored as an XML document in a relational database. If the task report handler 39 identifies the report as an important event, it will create an opportunity signal that recommends a buy or sell of the equity and passes that opportunity signal to the profile miner 40.

TASK_HANDLER_MAP

| | |
|---|---|
| Task 1 | Handler A |
| Task 2 | Handler B |
| Task 3 | Handler A |
| Task 4 | Handler C |

When a task 22 completes, the assignment broker 35 is notified. The assignment broker 35 marks the assignment 28 as complete. It then requests the next highest priority assignment 28 from the assignment manager and assigns it to the distributed agent.

Asynchronous Task Cancellation

Normally, a task's lifecycle runs smoothly through its phases and the task 22 will only terminate when the task's internal logic is satisfied (and notifies its task wrapper 68 that it has completed.) Two circumstances, however, will cause a task 22 to terminate before it is completed: the distributed agent terminates or the server 14 sends a remote task cancellation message. The case of distributed agent 24 termination happens regularly and is explained in further detail in the distributed agent lifecycle section. When the distributed agent terminates it orders the task manager 26 to terminate and release all tasks.

The more infrequent case is a message from the server 14 to cancel a particular task 22. Even though this case is not expected, a variety of system wide conditions could call for the ability to end a particular task 22. The distributed agent 24 locates the matching task 22 and terminates the task 22 by removing all associated resources. If the command receiver 62 receives a termination message for a task 22 that was never assigned to it, then the call is unnecessary and is ignored.

Distributed Agent Lifecycle

At the highest level of abstraction the distributed agent 24, also called a worker, has three phases in its lifecycle: initialization, operation, and termination. The iteration through the lifecycle is known as a session.

The initialization phase begins immediately after the distributed agent 24 begins execution. The distributed agent is installed on the user computer 12a-12c and executed when the user logs in to the server 14. First, the local configuration information, which can include a unique mode identification, or installation time, is loaded. The local configuration is a versatile and expandable method of storing options and prior actions of the distributed agent 24. The unique identification name, for example, is stored in this configuration so that it may be provided automatically to the server 14 during login. Other examples for the local configuration include options for remembering previous window positions and whether or not to launch the distributed agent 24 each time the underlying operating system restarts.

The next step in the initialization phase is to verify a connection with the server 14. For this to occur, a user logs into the server 14 and the login identification information must be authorized by the server 14. Login identification information consists of a valid username, password, and confirmation code. If the login identification information submitted by the distributed agent 24 is not authorized, then the connection is not verified and the distributed agent must resubmit login the username, password, and confirmation code. Once the login identification information has been authorized the distributed agent 24 is recognized by the server and is considered online. The initialization phase is now complete and the operation phase begins.

The operation phase is the core of the lifecycle and the most significant to the system. For the duration of this phase the distributed agent 24 is available to the server 14 to receive and execute tasks. During this phase, the distributed agent does not take explicit action. Instead the agent 24 provides the environment necessary for server communication, task assignment and execution, and trade placement.

The termination phase of the agent 24 begins once the decision is made to halt execution of the distributed agent. A full phase is necessary here to properly disconnect from the server 14. Any active tasks are cancelled. The local configuration is saved so that appearance and behavior changes are preserved for the next session. Finally the distributed agent 24 has completed the current session and exits.

The User Profile Miner

Once the server 14 receives opportunity signals about one or more financial instruments, the profile miner 40 is used to filter the opportunity signals and generate personal trade messages. Each user of the system 10 has an investor profile that will be matched against a repository of trading symbols and their attributes and used to determine the trade sizes. The profile miner 40 is the component of the system responsible for the filtering and customization of each trade.

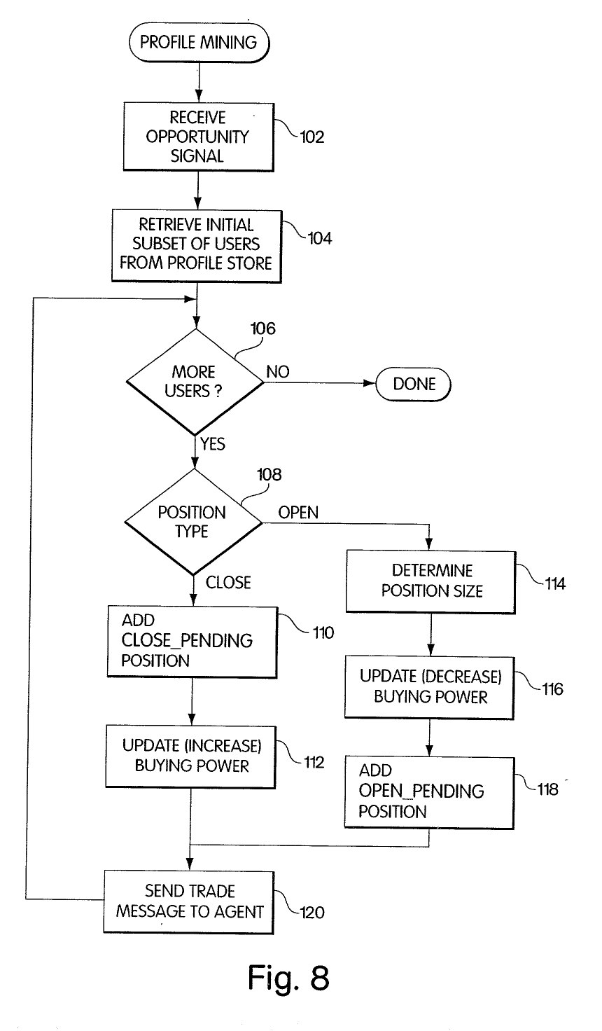

Whenever a distributed agent 24 executes a task 22 there is the possibility that the task's handler 39 will generate one or more opportunity signals. Referring to the flowchart of FIG. 8, these opportunity signals are sent to the profile miner 40 on the server for immediate processing at 102. The opportunity signal, for example, can contain the name of a company ticker symbol (in NASDAQ, NYSE, etc). This symbol name is used to determine the set of matching users whose profiles indicate that they are interested in trading this symbol at 104. To aid in this filtering process the server 14 uses profile matching functions. The following example matching function would match the symbol's market capitalization to a user's preference for company size:

private int marketCapToCompanySize (long marketCap) {

if (marketCap<ServerConstants.Symbol.MC_LOWEST)

return ServerConstants.InvestmentProfile.COMPANY_SIZE_SMALLEST;

if (marketCap<ServerConstants.Symbol.MC_LOW)

return ServerConstants.InvestmentProfile.COMPANY_SIZE_SMALL;

if (marketCap<ServerConstants.Symbol.MC_HIGH>

return ServerConstants.InvestmentProfile.COMPANY_SIZE_MEDIUM;

if (marketCap<ServerConstants.Symbol.MC_HIGHEST)

return ServerConstants.InvestmentProfile.COMPANY_SIZE_LARGE;

return ServerConstants.InvestmentProfile.COMPANY_SIZE_LARGEST;}

The matching functions are used as part of a larger query to select a subset of users who are interested in trading the symbol indicated in the incoming opportunity signal. Once the initial set of matching users is found, the profile miner 40 begins to iterate through the set 106.

If the position type of the opportunity signal is open the profile miner 40 will determine the position size at which to trade the securities at 114 for each online user. The price at which to conduct the trade is indicated in the opportunity signal as the signalprice. In addition, the opportunity signal contains a signal strength indicator, which is used to determine the position sizes for each user. The signal strength is a task dependent value (between 0.0 and 1.0) that represents the task model's confidence in its trading opportunity recommendation. For example, the 5-day breakout model could determine the signal strength by comparing the difference in the content equity price and the 5-day historical high of that equity. The position size of a particular trade is determined by the following calculation:

PositionSize=(minValuePerTrade+((maxValuePerTrade−minValuePerTrade)*signalStrength))/signalPrice

Where minvaluepertrade and maxvaluepertrade are attributes of the user's investor profile. The value of each trade is personalized according to the user's investor profile. The profile miner 40 then updates (decreases) each user's buying power in their investor profile by the size of the position at 116 plus commissions and friction. The user's buying power is the total amount of cash or credit line they have available for the opening of new positions. The profile miner 40 then uses the portfolio manager 41 to add a new position record as open_pending at 118. Finally, a trade message is sent to the user's distributed agent 24 for trade execution 120.

If the position type of the trade signal is a close, the profile miner 40 proceeds to update each user's portfolio by instructing portfolio manager 41 to update all open positions for the security for the user to close_pending. The portfolio manager 41 also returns the position size of the trade as part of this operation at 110. Again the price at which to conduct the trade is indicated in the opportunity signal. The profile miner 40 then updates (increases) the user's buying power in their investor profile by the amount of this trade at 112 minus commissions and friction. Finally a trade message 144 is sent to the user's distributed agent for trade execution at 120. Each trade message should contain some standard parameters for the distributed agent to execute the trade.

The parameters for each trade message 144 preferably contain, but are not limited to, the following: an action (i.e. Buy or sell), a symbol to trade, a quantity (how many shares to buy or sell), a limit price to accept, a reference to a trading module (i.e. Information to identify the brokerage, and subsequent software code, with which to trade), and any necessary trading account information for the user of the specified distributed agent 24.

It should be noted that if the server 14 receives multiple opportunity signals for the same security, the server 14 can use these signals to verify their accuracy by comparing their reported values.

Portfolio Management

The portfolio manager 41 is responsible for maintaining a persistent representation of each user's current holdings of financial instruments, such as equities. A portfolio is made up of zero or more positions, which are maintained in a database. A position consists of a stock symbol, a quantity, entry and exit prices, entry and exit dates, and the current state of the position—pending open, open, pending close, close, and cancelled. A position is in a pending state if it has not yet received a confirmation from the distributed agent that the trade has successfully completed. A user's total portfolio value is the sum of the current values of all of his or her open positions, plus his or her current buying power, or cash on hand.

Trade Execution

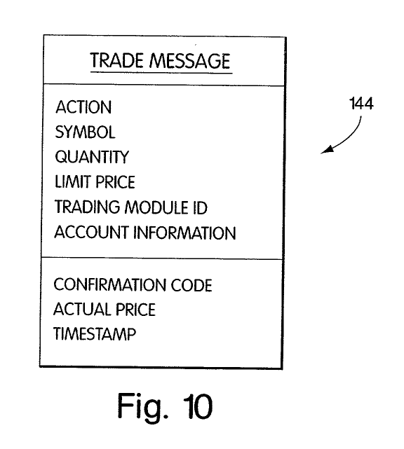

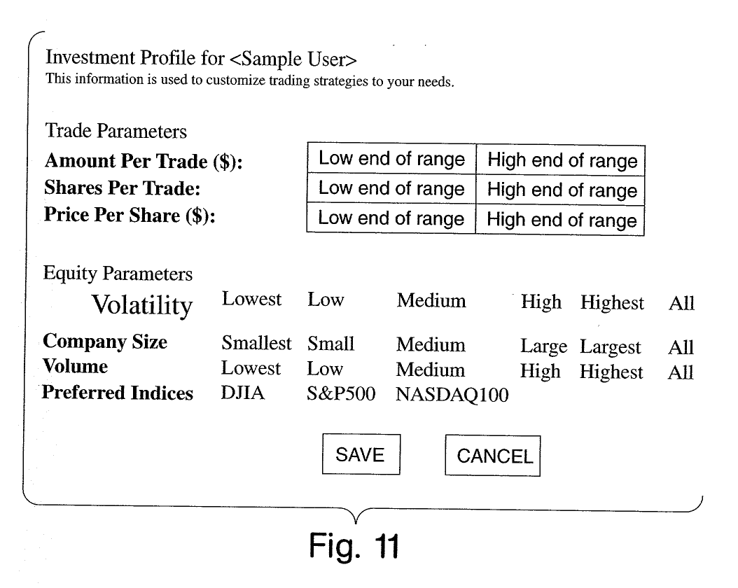

A trading module 27 specific to each user handles trade execution for each distributed agent. The trading module interfaces with an external service to place the trade as specified in the trade message. When a trade message is sent from server to a distributed agent, the distributed agent is responsible for reporting a trade confirmation message back to the server. A sample trade message 144 is shown in FIG. 10. The server then directs the trade confirmation to portfolio manager 41.

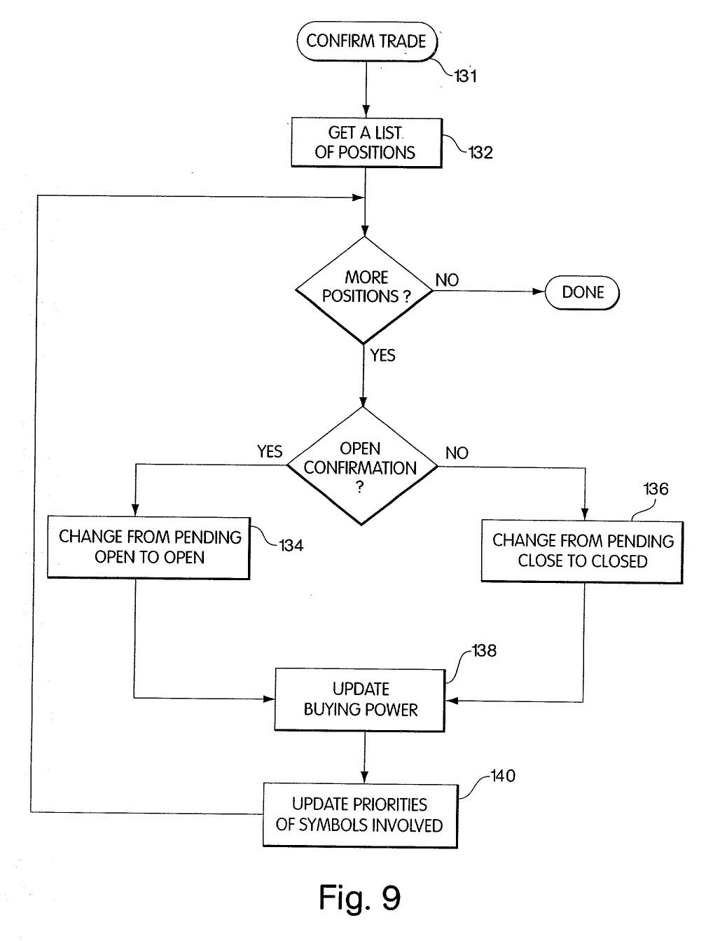

Referring to the flowchart of FIG. 9, the portfolio manager 41 is called to confirm a trade at 131 when the distributed agent sends the server a trade message. The portfolio manager 41 first gets a list of all the positions involved in the trade. For example, when an equity is sold, it might close several open positions. When the trade message confirms the opening of a position, the position's state is changed from pending open to open 114. When the trade message confirms the closing of a position, the position's state is changed from pending close to closed at 136. The user's buying power in the user investment profile is then updated to reflect the new state of the position at 138. Finally, the portfolio manager 41 informs the assignment manager that a position is in a new state at 140. The assignment priority manager 33 changes the priority of the symbol in the position as appropriate.

An Illustrative Example of Providing Distributed Investment Information—The 5-Day Breakout Model

As noted above, the 5-day breakout model uses a momentum trading strategy. The assumption is that an equity which moves above its 5-day high will continue to rise and the model should go long; conversely, an equity that drops below its 5-day low will continue to drop and the model should go short. For simplicity, the disclosure herein will only describe the 5-day breakout model with respect to long positions. In other words, the model will enter a position when a long signal is generated, hold for a period of time, and exit the position when a short signal is generated.

Using the architecture described herein, the 5-day breakout model is broken down into two parts—the task 22, which watches the securities throughout market hours, and a task report handler 39, which receives signals from the task 22 and determines which signals to transmit to the profile miner 40 on the server. When the task 22 is first instantiated and executed by the distributed agent, it queries a data source for the closing prices of the past 5 trading days. From these closing prices, the task 22 determines the highest price of the last 5 days and the lowest price of the last 5 days of the equity being analyzed. The task 22 then requests current quotes from the data source and continues doing so until the end of the market day. If the current price is higher than the high of the last 5 days, the task 22 generates a long signal and passes that signal back to the server as an XML document via the task report messaging service. If the current price is lower than the low of the last 5 days, the task 22 generates a short signal and passes that signal back to the server as well. Once the current price of an equity generates a signal, it is very likely that it will continue to generate a signal throughout the day, in other words, once an security's price goes above the 5-day high, it will very likely be above the 5-day high with each subsequent quote. To reduce traffic between the distributed agent and the server, the task 22 maintains a local state of each security. Once a long signal is generated, no more signals will be generated for that equity unless it drops below the 5-day low, thereby producing a short signal.

<5DayBreakout : Report>

<5DayBreakout : Instrument>

<5DayBreakout : Symbol>MSFT</SDayBreakout Symbol>
<5DayBreakout : Position>LONG</SDaysreakout : Position>
<5DayBreakout CurrentPrice>80 5</5Bayareakout : Currentprice>

</5DayBreakout : Instrument>

</5DayBreakout : Report>

The 5-day breakout model's task report handler 39 component is a relatively simple implementation in that it passes all new buy and sell trade signals on to the profile miner 40, but no redundant signals are passed on. For example, if a task generates a signal to go long MSFT, the task report handler 39 passes a buy signal to the profile miner 40 and any subsequent long signals are not passed on; however, if a signal to go short MSFT is received, a sell signal is passed on because it is a new signal and it causes the model to have a new state. The 5-day breakout model's state is maintained as an XML document indicating whether the model is currently long or short a particular equity. If the model is long MSFT, a long MSFT report was generated at some point by a task 22 and all subsequent long MSFT reports are to be ignored. Conversely, if the model is short MSFT, a short MSFT report was received at some point from a task 22 and all subsequent short MSFT signals are ignored. If a particular security does not have an entry in the model state XML document, a new entry is created in the document and the appropriate trade signal is passed on to the profile miner 40.

<5DayBreakout : ModelState>

<5DayBreakout : Instrument>

<5DayBreakout : Symbol >MSFT</5DayBreakout : Symbol>
<5DayBreakout : Position>LONG</5DayBreakout : Position>
<5DayBreakout : Currentprice>80 5</5DayBreakout : CurrentPrice>
</5DayBreakout : Instrument>

<5DayBreakout : Instrument>

<5DayBreakout : Symbol>CSCO</SdayBreakout : Symbol>
<5DayBreakout : Position>SHORT</5DayBreakout : Position>
<5Dayareakout : CurrentPrice>81.25</SdayBreakout : CurrentPrice>

</5DayBreakout : Instrument>

<5DayBreakout : ModelState>

Software used with embodiments of the present invention can be stored on computer usable medium for storing data, such as, for example, but not limited to, floppy disks, magnetic tape, zip disks, hard drives, CD-ROM, optical disks, or a combination of these.

Having thus described an illustrative embodiment of the invention, various alterations, modifications and improvements will readily occur to those skilled in the art. Such alterations, modifications and improvements are intended to be within the scope and spirit of the invention. Accordingly, the foregoing description is intended to facilitate understanding of the invention and is not intended as limiting. The invention's limit is defined only in the following claims and the equivalents thereto.

What is claimed is:

1. A method of providing information obtained over a computer network to a plurality of users each using a remote computer, the method comprising:
obtaining a plurality of investor profiles each specifying a user's investment preferences;
defining at least one task as a function of the investment preferences;
monitoring information about one or more financial instruments by at least one of the plurality of tasks being executed on a client computer;
receiving from the tasks information about the one or more financial instruments; and
distributing the information about the one or more financial instruments to at least one of the plurality of users as a function of said user's investment preferences.

2. The method of claim 1, further comprising initializing and executing the task on an agent.

3. The method of claim 1, further comprising creating an assignment for each task to record information thereabout on a database.

4. The method of claim 1, further comprising managing a priority of each assignment such that an assignment having a higher priority is distributed to an agent before an assignment having a lower priority.

5. The method of claim 4, wherein the priority of each assignment is based upon a number of agents that require completion of an assignment..

6. The method of claim 1, wherein receiving from the tasks information about the one or more financial instruments comprises receiving a task report message including a node identification and an identification of the task.

7. The method of claim 1, further comprising filtering the information about the one or more financial instruments received from the tasks to determine one or more users that would like to receive one or more pieces of the information based upon the investment strategy of each user.

8. The method of claim 1, further comprising receiving from one of the tasks a task report message that includes an identification of the task, a status of the task and at least one piece of information about one or more financial instruments.

9. The method of claim 1, further comprising:
creating an assignment for each task to record information thereabout on a database; and
wherein distributing the information about the one or more financial instruments to at least one of the plurality of users as a function of said user's investment preferences, comprises:
filtering the information about the one or more financial instruments received from the tasks to determine one or more users that would like to receive one or more pieces of the information based upon the investment strategy of each user; and
distributing the information about the one or more financial instruments to the plurality of users

10. The method of claim 9, further comprising managing a priority of each assignment such that an assignment having a higher priority is distributed to an agent before an assignment having a lower priority.

11. A method of providing information about one or more financial instruments to a remote server over a computer network, the information to be used by at least some of a plurality of users each having an investor profile that includes investor preferences and each using a computer, the method comprising:
receiving and executing one or more tasks on one of the computers of one of the users, at least one of the tasks for monitoring information about one or more financial instruments; and
transmitting the information about the one or more financial instruments to a server such that the server can distribute the information about the one or more financial instruments to at least some of the plurality of users based upon each investor profile.

12. The method of claim 11, further comprising verifying a connection with the server.

13. The method of claim 11, wherein the one or more tasks each include an assignment that includes information of the type of task, the current state of the assignment, and an identification of the node that is executing the task.

14. A method of providing to a remote computer information obtained over a computer network to a plurality of users, each of the users having a remote computer and each having an investor profile specifying the user's investment preferences, the method comprising:
receiving at least one task defined as a function of the investment preferences;
executing the at least one task to monitor information about one or more financial instruments;
transmitting to the remote computer information obtained from the at least one task about the one or more financial instruments such that the information about the one or more financial instruments can be distributed to the to at least one of the plurality of users as a function of said user's investment preferences.

15. The method of claim 14, wherein the remote computer is a remote server.

16. The method of claim 14, further comprising transmitting to the remote computer a task report message that includes an identification of the task, a status of the task and at least one piece of information about one or more financial instruments.

17. An apparatus for providing information obtained over a computer network to a plurality of users each using a remote computer, the apparatus comprising:
a server coupled to the computer network, wherein the server is programmed to:
obtain a plurality of investor profiles each specifying a user's investment preferences;
define at least one task as a function of the investment preferences;
monitor information about one or more financial instruments by at least one of the plurality of tasks being executed on a client computer;
receive from the tasks information about the one or more financial instruments; and
distribute the information about the one or more financial instruments to at least one of the plurality of users as a function of said user's investment preferences.

18. The apparatus of claim 17, wherein the server is further programmed to create an assignment for each task to record information thereabout on a database.

19. The apparatus of claim 18, wherein the server is further programmed to manage a priority of each assignment such that an assignment having a higher priority is distributed to an agent before an assignment having a lower priority.

20. The apparatus of claim 19, wherein the priority of each assignment is based upon a number of agents that require completion of an assignment.

21. The apparatus of claim 17, further comprising a task report message that provides from the tasks information about the one or more financial instruments, the task report message including a node identification and an identification of the task.

22. The apparatus of claim 17, further comprising filtering the information about the one or more financial instruments received from the tasks to determine one or more users that would like to receive one or more pieces of the information based upon the investment strategy of each user.

23. The apparatus of claim 17, further comprising receiving from one of the tasks a task report message that includes an identification of the task, a status of the task and at least one piece of information about one or more financial instruments.

24. An apparatus for providing information about one or more financial instruments to a remote server over a computer network, the information to be used by at least some of a plurality of users each having an investor profile that includes investor preferences and each using a computer, the apparatus comprising:
an agent programmed to execute on a computer, wherein the agent is programmed to:
receive and execute one or more tasks on one of the computers of one of the users, at least one of the tasks for monitoring information about one or more financial instruments; and
transmit the information about the one or more financial instruments to a server such that the server can distribute the information about the one or more financial instruments to at least some of the plurality of users based upon each investor profile.

25. The apparatus of claim 24, wherein the agent is further programmed to verify a connection with the server.

26. The apparatus of claim 24, wherein the one or more tasks each include an assignment that includes information of the type of task, the current state of the assignment, and an identification of the node that is executing the task.

27. An apparatus for providing to a remote computer information obtained over a computer network to a plurality of users, each of the users having an investor profile specifying the user's investment preferences, the apparatus comprising:
a client computer coupled to the computer network, wherein the client computer is programmed to:
receive at least one task defined as a function of the investment preferences;
execute the at least one task to monitor information about one or more financial instruments;
transmit to a remote computer information obtained from the at least one task about the one or more financial instruments such that the information about the one or more financial instruments can be distributed to the to at least one of the plurality of users as a function of said user's investment preferences.

28. The apparatus of claim 27, wherein the remote computer is a remote server.

29. The apparatus of claim 28, wherein the client computer is further programmed to transmit to the remote computer a task report message that includes an identification of the task, a status of the task and at least one piece of information about one or more financial instruments.

30. A system for providing information obtained over a computer network to a plurality of users each using a remote computer, the method comprising:
a first computer coupled to the computer network, wherein the first computer is programmed to:
obtain a plurality of investor profiles each specifying a user's investment preferences;
define at least one or more tasks as a function of the investment preferences;
receive from the tasks information about the one or more financial instruments; and
distribute the information about the one or more financial instruments to at least one of the plurality of users as a function of said user's investment preferences; and
a second computer coupled to the computer network, wherein the second computer is programmed to:
receive and execute the one or more tasks on one of the computers of one of the users; and
monitor information about one or more financial instruments by executing at least one of the one or more tasks;
transmit the information about the one or more financial instruments to the first computer.

31. An article of manufacture, comprising:
a computer readable medium having computer readable program code for authenticating a user of a client computer over a computer network, the computer readable program code including instructions for:
causing the computer system to obtain a plurality of investor profiles each specifying a user's investment preferences;
causing the computer system to define at least one task as a function of the investment preferences;
causing the computer system to monitor information about one or more financial instruments by at least one of the plurality of tasks being executed on a client computer;
causing the computer system to receive from the tasks information about the one or more financial instruments; and
causing the computer system to distribute the information about the one or more financial instruments to at least one of the plurality of users as a function of said user's investment preferences.

32. The article of manufacture of claim 31, wherein the instructions for causing the computer system to initialize and execute the task on an agent.

33. The article of manufacture of claim 31, wherein the instructions for causing the computer system to create an assignment for each task to record information thereabout on a database.

34. The article of manufacture of claim 31, wherein the instructions for causing the computer system to manage a priority of each assignment such that an assignment having a higher priority is distributed to an agent before an assignment having a lower priority.

35. The article of manufacture of claim 31, wherein the instructions for causing the computer system to filter the information about the one or more financial instruments received from the tasks to determine one or more users that would like to receive one or more pieces of the information based upon the investment strategy of each user.

36. The article of manufacture of claim 31, wherein the instructions for causing the computer system to receive from one of the tasks a task report message that includes an identification of the task, a status of the task and at least one piece of information about one or more financial instruments.
